(19) United States
(12) Patent Application Publication
(10) Pub. No.: US 2003/0131695 A1
(43) Pub. Date: Jul. 17, 2003

(54) Anti-skip fastener tightening and/or extraction device

(76) Inventor: Burton Kozak, Chicago, IL (US)

Correspondence Address: CHERSKOV and FLAYNIK, SUITE 1447, 20 NORTH WACKER DR., CHICAGO, IL, 60606, US

(21) Appl. No.: 10/045,423

(22) Filed: Jan. 12, 2002

(51) Int. Cl. B25B 23/00

(52) U.S. Cl. 81/460

(57) ABSTRACT

An anti-skip fastener tightening and/or extraction device 10 includes a tool bit end 12 having a plurality of flutes or crossing members 13-16, each crossing member having at least one recess 18 and 26 positioned in a side wall 20,21,28 and 29. The recesses 18 and 26 form edges 36 and 42 that engage corresponding portions of a fastener 17 to maintain engagement between the tool bit end 12 and the fastener 17 when forcibly rotating the fastener 17 to drive the fastener 17 into a workpiece or forcibly rotating the fastener 17 to extract the fastener 17 from a workpiece.

### BACKGROUND OF THE INVENTION

1. Field of the Invention

The present invention relates generally to fastener driver tool bits and, more particularly, to fastener driver tool bits that include features that prevent or reduce the tendency of a tool bit end to “skip” or “slide out” from the slots in fastener heads.

2. Background of the Prior Art

Screwdrivers, tool bit fastener drivers, Phillips screwdrivers and the like, when inserting or extracting a fastener from a workpiece, will at times “slip” or “skip” from the slot in the head of a fastener while imparting rotary motion to the fastener. Generally, the bit end of the fastener driver skips from the fastener after the fastener has been completely inserted into the workpiece, or when attempting to remove a corroded or relatively “old” fastener from the workpiece. When the tool bit skips from the fastener, the end of the bit has a tendency to tear away or wear down a portion of the side walls forming the slot in the head of the fastener. Repeated skips can deform the slot side walls such that the tool bit is incapable of imparting rotary motion to the fastener.

Prior art driver bits have attempted to correct the skipping problem by including relatively small recesses in the side walls of the flutes or crossing members that form the tip or drive portion of the bit. The recesses form edges that grip or “bite” into the side walls of the slot to promote rotary motion transfer between the driver bit and fastener. The recesses are machined in each side wall of each crossing member such that a right angle is formed between the recesses and the longitudinal axis of the bit when taking a side elevation view of the bit. Further, recesses are machined radially across the flutes to form multiple concentric arc segments when taking a drive end elevation view of the bit as disclosed in U.S. Pat. No. 4,998,454.

The problem with prior art driver bits that include recesses that grip the side walls of the slot of the fastener, is that there are an excessive number of recesses which structurally weaken the bits causing the bits to routinely break or deform when rotary motion sufficient to rotate the fastener, is imparted upon the bit from a rotary driver. A need exist for a driver bit that is capable of gripping the side walls that form the slot in the head of a fastener, and that is sufficiently strong to impart, without deforming or breaking, required rotary motion upon the fastener.

### SUMMARY OF THE INVENTION

It is an object of the present invention to provide a screwdriver type tool bit that will not slide out from the slots (anti-skip) in a fastener when a rotary force is imposed upon the tool bit while inserting or extracting the fastener from a workpiece.

A principal object of the present invention is to provide an improved fastener driver that “grips” a side wall forming a slot in the head of the fastener. A feature of the improved fastener driver is one or more recesses in predetermined side walls of crossing members of a “Phillips type” screwdriver. An advantage of the improved fastener driver is that engagement between the driver and the fastener is maintained while the fastener is inserted into or extracted from a workpiece. Another advantage of the improved fastener driver is that constant rotary motion is imparted from the driver to the fastener when the fastener is inserted into or extracted from a workpiece.

Another object of the present invention is to provide gripping capability to a fastener driver while maintaining the structural strength of the driver. A feature of the improved fastener driver is one or more recesses forming edges that engage or “bite” into walls forming a driver receiving slot in a fastener. Another feature of the improved fastener driver is one or more recesses disposed in one of two side walls of each crossing member, the fastener driver being comprised of four crossing members. An advantage of the improved fastener driver is that the bit end of the driver maintains engagement with the fastener while imparting rotary force thereupon without bending or breaking the bit end.

Yet another object of the present invention is to provide a fastener driver having one or more recesses in side walls of the crossing members, the recesses being inclined relative to the longitudinal axis of the driver. A feature of the improved fastener driver is longer gripping edges formed by the inclined recesses. An advantage of the improved fastener driver is that gripping capability is increased without decreasing structural integrity.

Still another object of the present invention is to provide an improved blade type or “standard” fastener driver. A feature of the improved standard screwdriver is one or more recesses machined in opposing side walls of the screwdriver. An advantage of the improved standard screwdriver is that the screwdriver is capable of gripping a corresponding fastener thereby maintaining engagement between the screwdriver and fastener while the fastener is inserted into or extracted from a workpiece.

Another object of the present invention is to improve the gripping capability of a standard screwdriver while maintaining structural strength. A feature of the standard screwdriver is one or more recesses extending across a portion of each side wall forming the bit end of the screwdriver. An advantage of the standard screwdriver is that substantially the same amount of bitting edge from the partially extending recesses (compared to a recess extending totally across each side wall) engage the side walls forming the corresponding slot of the fastener thereby providing gripping capability and maintaining the quantity of rotational force that may be imparted from the screwdriver to the fastener.

Another object of the present invention is to improve the gripping capability of a Phillips screwdriver when inserted into relatively shallow receiving recesses disposed in a fastener. A feature of the screwdriver is one or more recesses disposed relatively close to the bit end. Another feature of the screwdriver is a crowned bit end formed from arcuate crossing members. An advantage of the screwdriver is that the entire edge of the recesses engage corresponding side walls of the recesses in the fastener to maximize gripping capability. Another advantage of the screwdriver is that the arcuate crossing members allow the crown portion of the bit end to engage a center portion of the fastener while the crossing members accommodate a foreign material built-up in the corners of the fastener recesses thereby promoting complete engagement between the edges of the recesses in the bit end and the walls of the recesses in the fastener.

Briefly, the invention provides an anti-skip fastener tightening and/or extraction device comprising a tool bit end having a plurality of crossing members, each crossing member having at least one recess positioned in a side wall, said recesses forming edges that engage corresponding portions of a fastener to maintain engagement between said tool bit end and the fastener when forcibly rotating the fastener to drive the fastener into a workpiece, said recesses forming edges that engage corresponding portions of the fastener to maintain engagement between said tool bit end and the fastener when forcibly rotating the fastener to extract the fastener from a workpiece.

### BRIEF DESCRIPTION OF THE DRAWINGS

The foregoing invention and its advantages may be readily appreciated from the following detailed description of the preferred embodiment, when read in conjunction with the accompanying drawings in which:

FIG. 1 is a perspective view of tool bit having recesses in a side wall in accordance with the present invention.

FIG. 2 is a front elevation view of the tool bit depicted in FIG. 1.

FIG. 3 is a top elevation view of the tool bit depicted in FIG. 1.

FIG. 4 is a back elevation view of the tool bit depicted in FIG. 1.

FIG. 5 is a top elevation view of a typical “Phillips type” fastener.

FIG. 6 is perspective view of an alternative embodiment of the tool bit depicted in FIG. 1 in accordance with the present invention.

FIG. 7 is a perspective view of an alternative tool bit having recesses in a side wall in accordance with the present invention.

FIG. 8 is a perspective view of an alternative tool bit for a fastener with relatively shallow tool bit receiving recesses.

FIG. 9 is a side elevation view of the end of the alternative tool bit of FIG. 8.

### DESCRIPTION OF THE PREFERRED EMBODIMENT

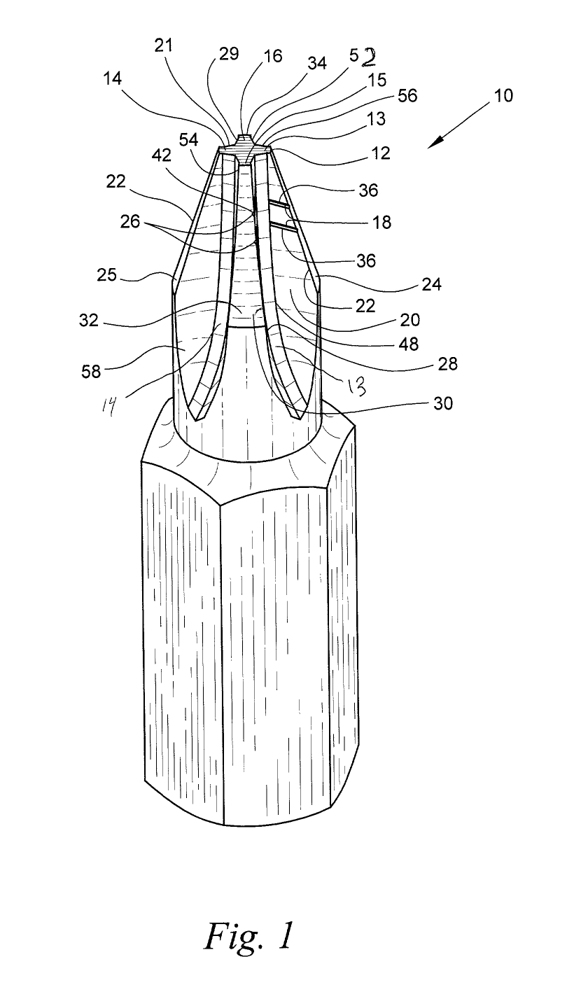

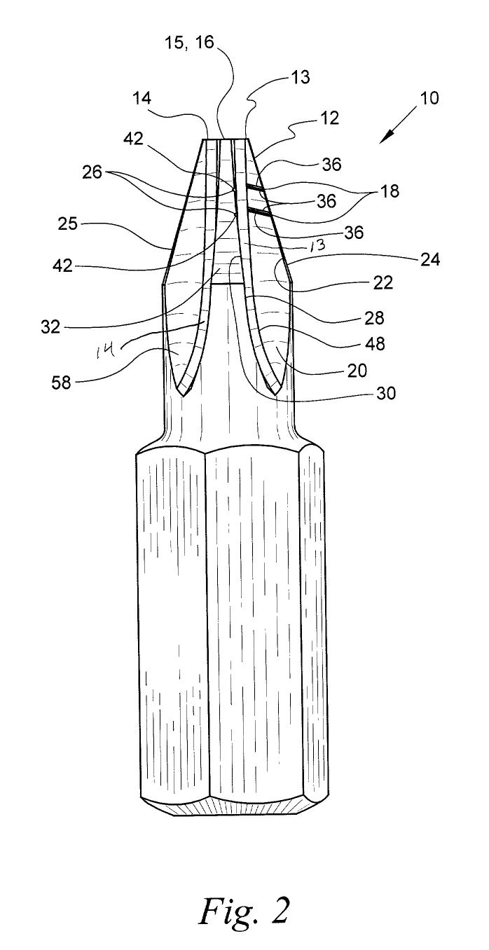

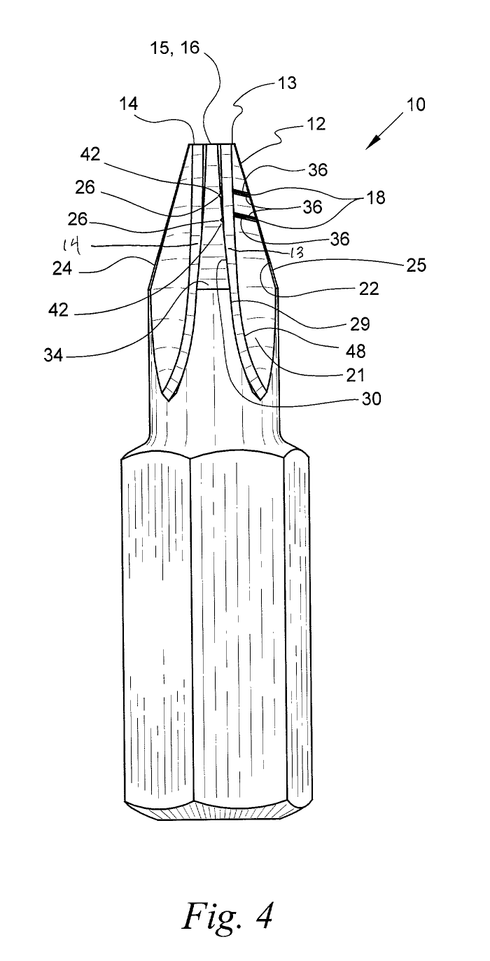

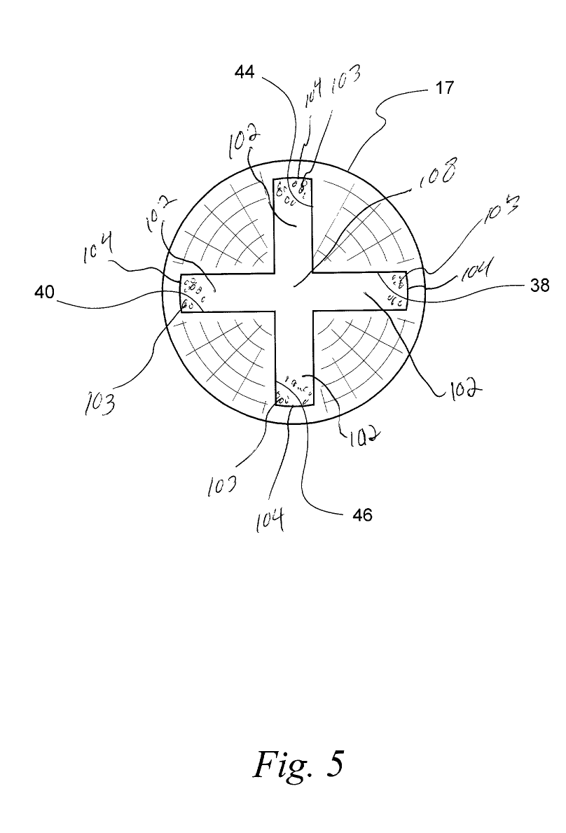

Referring now to FIGS. 1-5, an anti-skip fastener tightening and/or extraction device is denoted by numeral 10. The device 10 includes a tool bit end 12 having a cross configuration when taking an end view, and formed from four substantially identical crossing members 13, 14, 15 and 16 that are radially separated a substantially equal degree of arc thereby configuring a typical screwdriver bit for a standard cross or “Phillips” head fastener 17. Crossing members 13 and 14 have at least one, but preferably a plurality of parallel recesses 18 disposed in first side walls 20 and 21 such that an acute angle is formed (when taking a front elevation view of the device, see FIG. 2) between the recesses 18 and a mid-portion of an inclined edge 22 of first and second inclined walls 24 and 25 of members 13 and 14. Crossing members 15 and 16 have at least one, but preferably a plurality of parallel recesses 26 disposed in second side walls 28 and 29 such that an acute angle is formed (when taking a back elevation view of the device, see FIG. 4) between the recesses 26 and a mid-portion of an inclined edge 30 of first and second inclined walls 32 and 34 of the second crossing member 16.

The recesses 18 in first side walls 20 and 21 form edges 36 that engage and grasp the fastener 17 by “digging” into corresponding first side walls 38 and 40 of fastener 17 to maintain engagement between the tool bit end 12 and the fastener 17 when forcibly rotating the fastener 17 to drive the fastener 17 into a workpiece (not shown). The recesses 26 in the second side walls 28 and 29 form edges 42 that engage and grasp the fastener 17 by “digging” into corresponding second side walls 44 and 46 of fastener 17 to maintain engagement between the tool bit end 12 and the fastener 17 when forcibly rotating the fastener 17 to extract the fastener 17 from a workpiece. The recesses 18 and 26 are relatively narrow and substantially horizontal when taking front or back elevation views. The recesses 18 in the first side walls 20 and 21 extend across the first side walls 20 and 21 from an inner edge 48 to inclined edge 22 of corresponding inclined walls 24 and 25. The recesses 26 in the second side walls 28 and 29 extend across the second side walls 28 and 29 from an inner edge 48 to inclined edge 30 of corresponding inclined walls 32 and 34. The recesses 18 and 26 are separated a distance relatively larger than their lateral dimension and include a relatively shallow “depth” relative to the thickness of the crossing members 13-16 of the tool bit end 12.

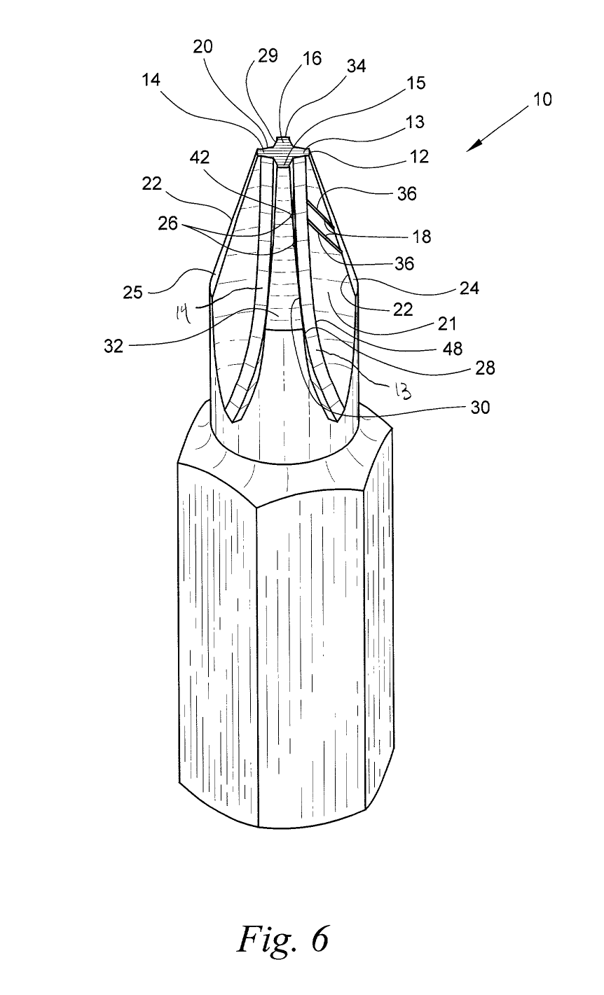

The recesses 18 and 26 may be orientated perpendicular or parallel to the central axis of the tool bit and may be positioned at any portion of the first and second side walls 20, 21, 28 and 29 depending upon the size of the fastener 17 and the corresponding “depth” of the first and second side walls 38, 40, 44 and 46 into the fastener 17. Generally, the deeper the first and second side walls of the fastener 17, the greater the longitudinal dimension of the recesses 18 and 26 across the first and second side walls of the tool bit end 12. The longitudinal dimension is increased by angling the recesses 18 and 26 to a more vertical position extending from the inner edge 48 to inclined edges 22 and 30, respectively as depicted in FIG. 6. Further, the recesses 18 and 26 may vary in quantity from one to a plurality of recesses depending upon the desired “griping” capability of the device 10 upon the fastener 17.

Although the figures depict only the first side walls 20 and 21 of crossing members 13 and 14, and the second side walls 28 and 29 of crossing members 15 and 16 having recesses therein, all eight side walls of the tool bit end 12 may include recesses to improve the gripping capability of the device 10. More specifically, second side walls 56 and 58 of crossing members 13 and 14, respectively, and first side walls 54 and 52 of crossing members 15 and 16, respectively, may include recesses configured and disposed substantially identical to the recesses 18 and 26 in corresponding side walls. However, adding recesses in the tool bit end 12 weakens the metal forming the end 12 thereby reducing the amount of rotational force that can be applied to the device 10 without deforming the end 12. Positioning recesses in opposing side walls of the same crossing member such that bottom portions are directly opposite, further reduces the rotational force that may be applied. To minimize metal degradation, recesses in opposing side walls of a crossing member may be staggered whereby the quantity metal separating opposing lower portions of corresponding recesses is increased. Thus, keeping the quantity of recesses to a minimum while adding optimum gripping capability to the tool bit end 12 and/or avoiding recesses in opposite side walls of one of the crossing members 13-16 increases the amount of rotary force that may be imparted upon a fastener 17.

Alternatively, the tool bit end 12 may be designed to provide gripping capability in only one rotary direction. More specifically, the tool bit end 12 may be required to grip the fastener 17 to assemble a workpiece thereby requiring the recesses to grip the fastener 17 for insertion only. Recesses that are disposed to remove fasteners would not be included. Should the tool bit end 12 be required to only remove fasteners 17 from a workpiece, recesses that grip the fasteners 17 for extraction would be machined in the tool bit end 12, recesses that insert fasteners 17 would not be included.

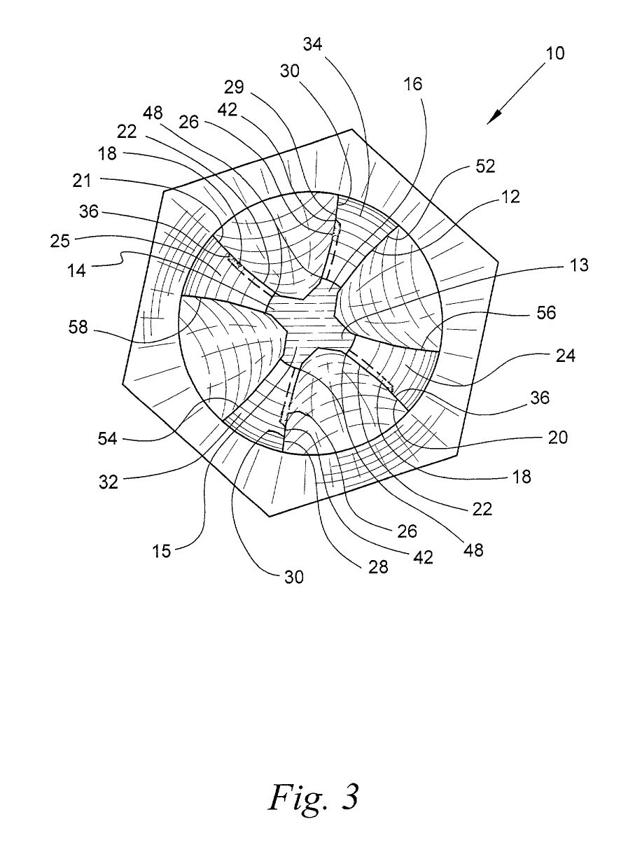

In operation, a standard screwdriver bit 12 configured to insert or remove a Phillips head fastener 17 from a workpiece, is machined via techniques well known to those of ordinary skill in the art such that one or more recesses 18 are formed in the first side walls 20 and 21 of crossing members 13 and 14 for gripping the first side walls 38 and 40 of the fastener 17 during the extraction (counter-clockwise rotation) of the fastener 17 from a workpiece. Alternatively, one or more recesses 26 are machined in the second side walls 28 and 29 of crossing members 15 and 16 for gripping the second side walls 44 and 46 of the fastener 17 during the insertion (clockwise rotation) of the fastener 17 into the workpiece. Should the bit 12 be required to grip the fastener 17 for both extraction and insertion, recesses 18 and 26 would be machined in corresponding first and second side wall 20,21,28 and 29. Should a relatively small amount of rotary force be imparted upon the fastener 17 by the bit 12, and a relatively large gripping capability be required to insert and/or extract the fastener 17 from a workpiece, recesses 18 and/or 26 may be machined in corresponding first side walls 20,21,52 and 54 and/or second side walls 28,29,56 and 58 of the crossing members 13,14,15 and 16 (see FIGS. 1 and 3).

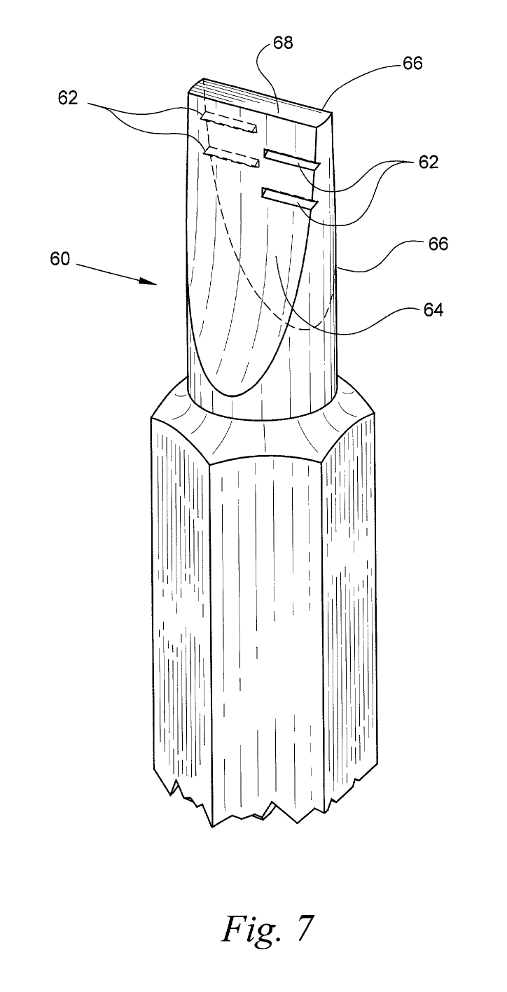

Referring now to FIG. 7, a standard “blade” screwdriver tip 60 is depicted having a plurality of recesses 62 machined in first and second sides 64 and 66 of the tip 60. The recesses 62 are parallel to the edge 68 of the tip 60, extend laterally across substantially half the tip 60, and include a “depth” relatively shallow in comparison to the “thickness” of the tip 60 thereby substantially maintaining the structural strength of the tip 60. The recesses 62 on each side 64 and 66 of the tip 60 are separated a distance relatively greater than the lateral dimension of the recesses 62. Machining recesses 62 across half the tip 60, maintains tip integrity but provides gripping capability in only one rotary direction. Extending the recesses 62 across the entire surface of the tip 60 would enable the tip 60 to grip the fastener in both rotary direction, but would decrease the structural strength of the tip 60 thereby reducing the amount of rotary force that may be imparted upon the screwdriver. Further, the recesses 62 may be inclined relative to the edge 68 or may be increased in quantity to increase the gripping capability of the tip 60, but resulting in a corresponding decrease in structural strength and the amount of rotational force that may be imparted from the tip 60 to the fastener. Staggering or varying the distances between the recesses 62 of the first side wall 64 and the edge 68 of the tip 60 relative to the distances between the recesses 62 of the second side wall 66 and the edge 68 of the tip, avoids “back-to-back” placement of the recesses 62, thereby substantially maintaining the structural integrity of the tip 60.

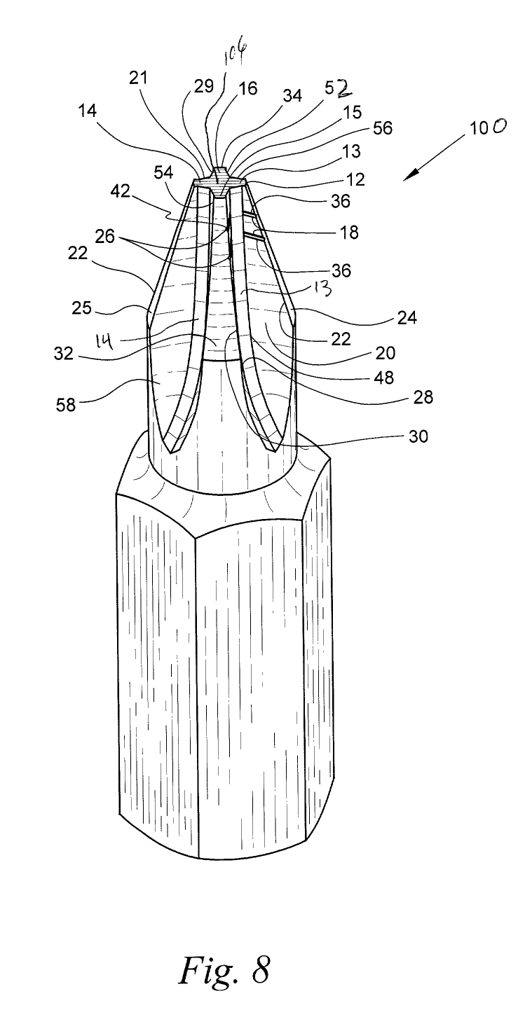

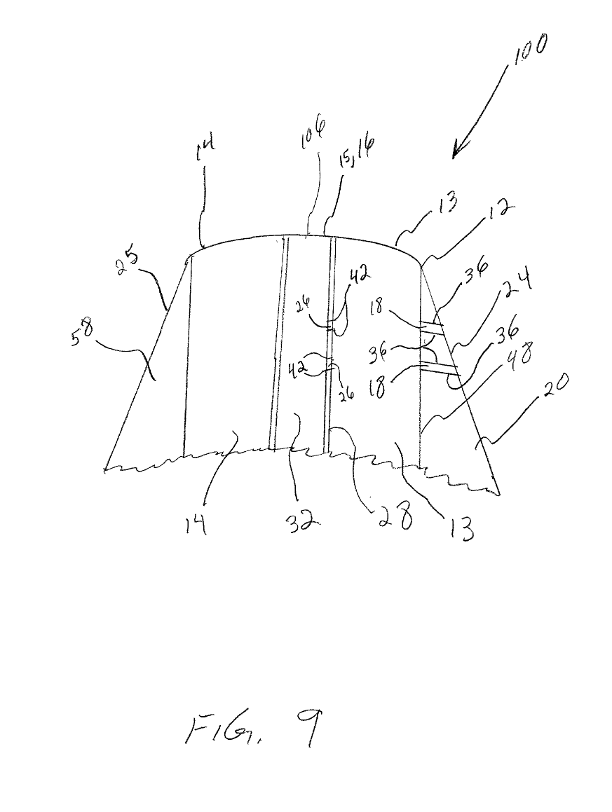

Referring now to FIGS. 8 and 9, an alternative anti-skip fastener tightening and/or extraction device is denoted by numeral 100. The device 100 of FIG. 8 is substantially the same as the device 10 of FIG. 1 except that the recesses 18 and 26 in the alternative device 100 have been disposed closer to the tool bit end 12 to engage corresponding side walls 38, 40, 44 and 46 of a fastener 17 having relatively “shallow” recesses 102 that form the side walls 38, 40, 44 and 46. The device 100 further includes arcuate crossing members 13-16 that accommodate a slight grease, dirt and/or metal filing “buildup” 103 in corners 104 of the recesses 102 in the fastener 17. Thus, the device 100 is allowed to insert into the fastener 17 until a slightly crowned portion 106 of the device 100 engages a center portion 108 of the fastener 17, and the arcuate crossing members 13-16 engage and forcibly compress the grease and dirt buildup 103. The arcuate configuration facilitates total engagement and maximum “gripping” capability between the recess 18 and 26 of the device 100 and the side walls of a fastener 17 with shallow recesses 102 that have a foreign material buildup therein.

The foregoing description is for purposes of illustration only and is not intended to limit the scope of protection accorded this invention. The scope of protection is measured by the following claims, which should be interpreted as broadly as the inventive contribution permits.

1. An anti-skip fastener tightening and/or extraction device comprising:
a tool bit end having a plurality of crossing members, each crossing member having at least one recess positioned in a predetermined side wall, said recesses forming edges that engage corresponding portions of a fastener to maintain engagement between said tool bit end and the fastener when forcibly rotating the fastener to drive the fastener into a workpiece or to extract the fastener from a workpiece.

2. The device of claim 1 wherein said crossing members include a plurality of recesses in first side walls of first opposing crossing members and a plurality of recesses in second side walls of second opposing crossing members.

3. The device of claim 2 wherein said plurality of recesses are perpendicular to the central axis of the tool bit.

4. The device of claim 2 wherein said plurality of recesses form an acute angle with the central axis of the tool bit.

5. The device of claim 2 wherein said plurality of recesses are parallel to the central axis of the tool bit.

6. The device of claim 1 wherein said crossing members include a plurality of recesses in second side walls of first opposing crossing members and a plurality of recesses in first side walls of second opposing crossing members.

7. The device of claim 6 wherein said plurality of recesses are perpendicular to the central axis of the tool bit.

8. The device of claim 6 wherein said plurality of recesses form an acute angle with the central axis of the tool bit.

9. The device of claim 6 wherein said plurality of recesses are parallel to the central axis of the tool bit.

10. The device of claim 2 wherein said first opposing crossing members include staggered recesses in opposing first and second side walls of each of said first opposing crossing members.

11. The device of claim 2 wherein said second opposing crossing members include staggered recesses in opposing first and second side walls of each of said second opposing crossing members.

12. An anti-skip fastener tightening and/or extraction device comprising:
a crowned tool bit end having arcuate crossing members and substantially parallel, planar walls that ultimately engage side walls forming a slot in a fastener, said planar walls of said tool bit end each having at least one recess configured to form edges that engage a portion of the side wall that forms the slot in the fastener.

13. The device of claim 12 wherein said planar walls of said tool bit include a plurality of recesses configured to form a plurality of edges that engage a portion of the side walls of the fastener.

14. The device of claim 12 wherein said plurality of recesses are perpendicular to the central axis of the tool bit.

15. The device of claim 12 wherein said plurality of recesses form an acute angle with the central axis of the tool bit.

16. The device of claim 12 wherein said plurality of recesses are parallel to the central axis of the tool bit.

17. The device of claim 12 wherein said plurality of recesses in a first planar wall are positioned opposite corresponding recesses in a second planar wall.

18. The device of claim 12 wherein said plurality of recesses in a first planar wall are staggered in relation to corresponding recesses in a second planar wall.

19. A method for providing an anti-skip fastener and/or extraction device, said method comprising:
providing a fastener driver;
positioning at least one recess in a predetermined side wall; and
forming edges that engage corresponding portions of a fastener to maintain engagement between said fastener driver and the fastener when forcibly rotating the fastener to drive the fastener into a workpiece and/or extracting the fastener from a workpiece.

20. The method of claim 19 wherein the step of providing a fastener driver includes the step of providing a tool bit end having means for gripping a fastener having relatively shallow recesses that receive the tool bit end.

21. The method of claim 20 wherein the step of providing a tool bit end having gripping means includes the step of disposing recesses adjacent to the tool bit end.

22. The method of claim 20 wherein the step of providing a tool bit end having gripping means includes the step of providing a crowned tool bit end.

23. The method of claim 20 wherein the step of providing a tool bit end having gripping means includes the step of providing arcuate crossing members.

24. An anti-skip fastener insertion device comprising:
a fastener driver;
at least one recess disposed in a predetermined side wall of said fastener driver; and
means for gripping corresponding portions of a fastener to maintain engagement between said fastener driver and the fastener when forcibly rotating the fastener to insert the fastener into a workpiece.

25. The device of claim 24 wherein said recess extends laterally across substantially half a tip portion of said fastener driver.

26. The device of claim 24 wherein said recess extends laterally across a tip portion of said fastener driver.

27. The device of claim 24 wherein recesses in opposing side walls of a tip portion of said driver are disposed in a staggered configuration.

28. The device of claim 24 wherein said recess extends laterally across a tip portion of said driver such that said recess is inclined relative to an edge of said tip portion.

29. An anti-skip fastener extraction device comprising:
a fastener driver;
at least one recess disposed in a predetermined side wall of said fastener driver; and
means for gripping corresponding portions of a fastener to maintain engagement between said fastener driver and fastener when forcibly rotating the fastener to extract the fastener from a workpiece.

30. The device of claim 29 wherein said recess extends laterally across substantially half a tip portion of said fastener driver.

31. The device of claim 29 wherein said recess extends laterally across a tip portion of said fastener driver.

32. The device of claim 29 wherein recesses in opposing side walls of a tip portion of said driver are disposed in a staggered configuration.

33. The device of claim 29 wherein said recess extends laterally across a tip portion of said driver such that said recess is inclined relative to an edge of said tip portion.
